(19) United States
(12) Patent Application Publication
(10) Pub. No.: US 2016/0007052 A1
(43) Pub. Date: Jan. 7, 2016

(54) LIVE STREAMING BROADCAST SERVICE WITH ARTIST AND FAN COMPETITIVE REWARD SYSTEM

(71) Applicant: Anthem Digital Media, Inc., Las Vegas, NV (US)

(72) Inventors: Stacy A. Haitsuka, Las Vegas, NV (US); John T. Kohl, Henderson, NV (US); Ofek Hayon, Henderson, NV (US); Christopher H. Murray, Henderson, NV (US)

(21) Appl. No.: 14/789,807

(22) Filed: Jul. 1, 2015

Related U.S. Application Data
(60) Provisional application No. 62/020,916, filed on Jul. 3, 2014.
(60) Provisional application No. 62/020,919, filed on Jul. 3, 2014.

(51) Int. Cl. H04N 21/2187; H04N 21/6405; H04N 21/2665; H04N 21/2743; H04N 21/231; H04N 21/2343

(52) U.S. Cl. CPC H04N 21/2187; H04N 21/231; H04N 21/2343; H04N 21/2665; H04N 21/2743; H04N 21/6405

(57) ABSTRACT

A server for live stream broadcasting of video comprises a network interface for receiving the video stream of a live event substantially simultaneously with the recording of the video stream to a server; and a processor for converting the video stream into a plurality of multicast video streams, each suitable for viewing by one of a plurality of computing devices. The network interface for simultaneously retransmitting the plurality of multicast video streams to the plurality of computing devices, and transmitting an announcement that the multicast video streams are available for viewing to a plurality of mobile devices

### RELATED APPLICATION INFORMATION

This patent claims priority from the following provisional patent applications:
U.S. provisional patent application Ser. No. 62/020,916 entitled “ARTIST AND FAN COMPETITIVE REWARD SYSTEM” filed Jul. 3, 2014.
U.S. provisional patent application Ser. No. 62/020,919 entitled “LIVE BROADCASTING SYSTEM” filed Jul. 3, 2014.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to live streaming broadcast service with artist and fan competitive reward system.

2. Description of the Related Art

The present application relates to a live streaming application, available to, for example, recording artists and comedians who may use the application to live stream events. The events may be live streamed from, for example, a mobile device to virtually any number of recipients over the Internet. There will be substantially no delay between the receipt of the video at a video camera and the subsequent transmission to end-users. The video stream may be substantially simultaneously stored on a server for later retransmission upon request.

The application also includes a social networking aspect that enables artists to share the live stream with social network followers in real-time. Social network users may then re-share that live stream to increase viewership and resulting in increased recognition of the artist. The system may track recognition to develop cumulative and “trending” popularity scores for the artist. These may be used by fans as a means of artist discovery or by businesses seeking artists for use in identifying artists to whom recording, endorsement, and other contracts may be extended.

### DESCRIPTION OF THE DRAWINGS

FIG. 1 is a depiction of a system for live event distribution.

FIG. 2 is a depiction of a system for live event broadcasting.

FIG. 3 is a depiction of a system that acts as a live event social portal, application and/or website.

FIG. 4 shows a computing device.

FIG. 5 is a depiction of a user interface for a live event social portal, application, and/or website.

FIG. 6 shows the integration of a live event broadcast into a social portal, application, and/or website.

FIG. 7 shows a system for collecting and processing artist scores.

FIG. 8 is a flowchart of the process of live event broadcasting.

FIG. 9 is a flowchart of artist scoring.

FIG. 10 shows an example of artist scoring based upon fan activities.

FIG. 11 is an example of the types of fan activities and their results on artist scoring.

FIG. 12 is an example of multi-level fan scoring reward system.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

### Description of Apparatus

There is disclosed a live streaming application (the “App”) which is a platform that allows artists and musicians (“users”) broadcast live real time video from mobile devices, tablet computers, laptop computers and desktop computers, plus other internet-connected media devices. Live broadcasting software utilizes hardware device resources to compress and transmit video to proprietary servers, and/or 3rd party websites including, but not limited to, YouTube, Facebook, and Twitter. The App is capable of simultaneously broadcasting live video to both proprietary and 3rd party websites and applications. The App utilizes cloud-based server technology to record (“DVR”) live video broadcasts and then stores recorded videos on proprietary servers, and/or submits the recorded video to 3rd party websites such as YouTube, Facebook and Twitter.

The App will transform how artists communicate with music fans, by offering a platform to broadcast live events to an unlimited number of viewers. The App is a powerful live streaming social media application that will allow artists to broadcast standard-definition (SD) and High Definition (HD) video to their fans and social media followers. The App will allow artists to utilize their iOS and Android mobile devices to broadcast live video, over a global network, to audiences located anywhere in the world. The live streaming platform also allows users to broadcast live events from their Windows and Mac computers. The App is designed to provide artists and musicians with a user-friendly method of broadcasting live events and concerts, backyard “garage-band” performances, in-studio updates, backstage behind the scenes footage, or any other form of live video-based interaction. The 2013 Oxford Dictionary Word of the Year was “selfie”—The App allows artists to broadcast “video-selfies” to their music fans by allowing artists to alternate between the default front-facing and back-facing cameras that are installed on iOS and Android devices.

The App is a powerful social media application that will allow artists to broadcast live video to their fans and social media followers. Artists will utilize the App to simultaneously broadcast live video to their personal YouTube, Facebook and Twitter accounts. The App allows artist to send alerts to their mobile contacts and social media friends and followers upon the initiation of the live broadcast. The App supports live video playback inside Facebook and Twitter—This means that live video plays inside the Facebook Timeline and News Feed, and plays inside the Twitter feed. This is an incredibly powerful social media feature that is proven to have more “viral reach” than simply providing a link that directs users back to a 3rd party app or website. Viewers can easily share the live video post with their friends and followers. Artists will utilize the App to broadcast live video to their social media followers on the world's most popular social networking websites.

Artists and musicians will utilize the App to broadcast live video to their mobile contacts. Artists can easily share video broadcasts via SMS/MMS and playback is supported on mobile and tablet devices. Similar to the popular messaging app WhatsApp, artists will utilize the App to distribute live events to individual mobile contacts, or will have the ability to send alerts to all their mobile contacts at once.

The App will allow artists to either schedule live events, or create spontaneous live events. Users can “announce” live events, both scheduled and spontaneous, to their mobile contacts and social sites. Artists will utilize the scheduling feature to send announcements and invitations to join upcoming future live broadcasts, plus follow up announcements will be automatically sent upon the initiation of the live events.

The App includes cloud-based DVR technology that records live video as it is broadcast. Artists and musicians will utilize this feature to record and archive their live events. The App allows artists to automatically post recorded videos of live events to their social sites, including YouTube, Facebook and Twitter, among other popular social networking websites and apps. The App will be utilized by artists and a complete video-broadcasting solution, capable of streaming live video, with the option to automatically record and auto-post the recorded video of the live event to the user's social networking websites.

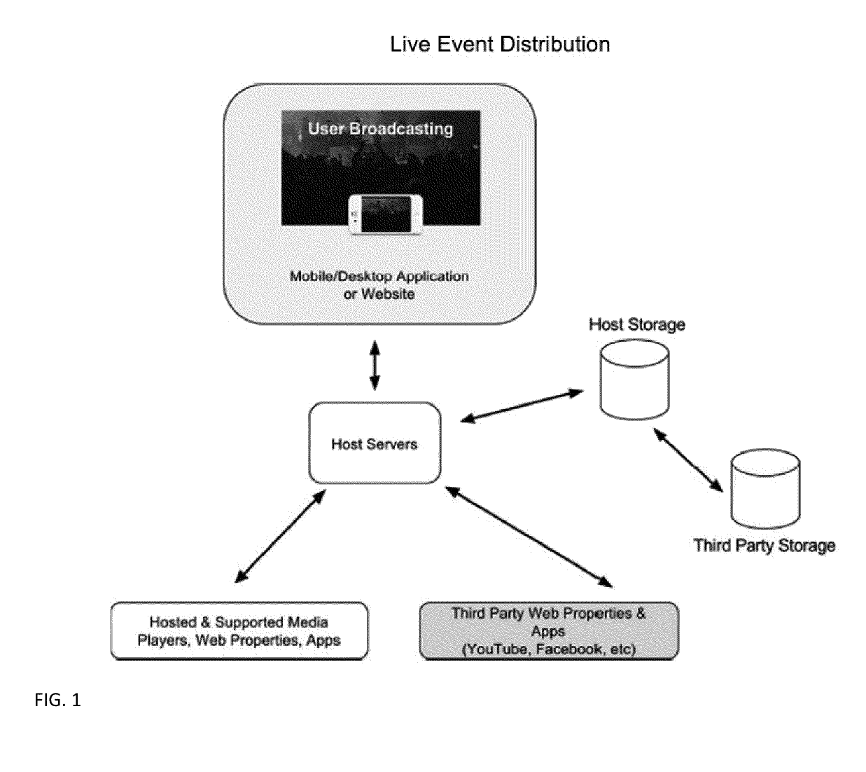

As shown in FIG. 1, the App resides on a global cloud-based network that will allow artists to broadcast live video to an unlimited number of viewers, located anywhere in the world, assuming there is an internet connection, and interoperates with a global network built on a world-class Content Delivery Network (CDN) capable of supporting a massive worldwide audience.

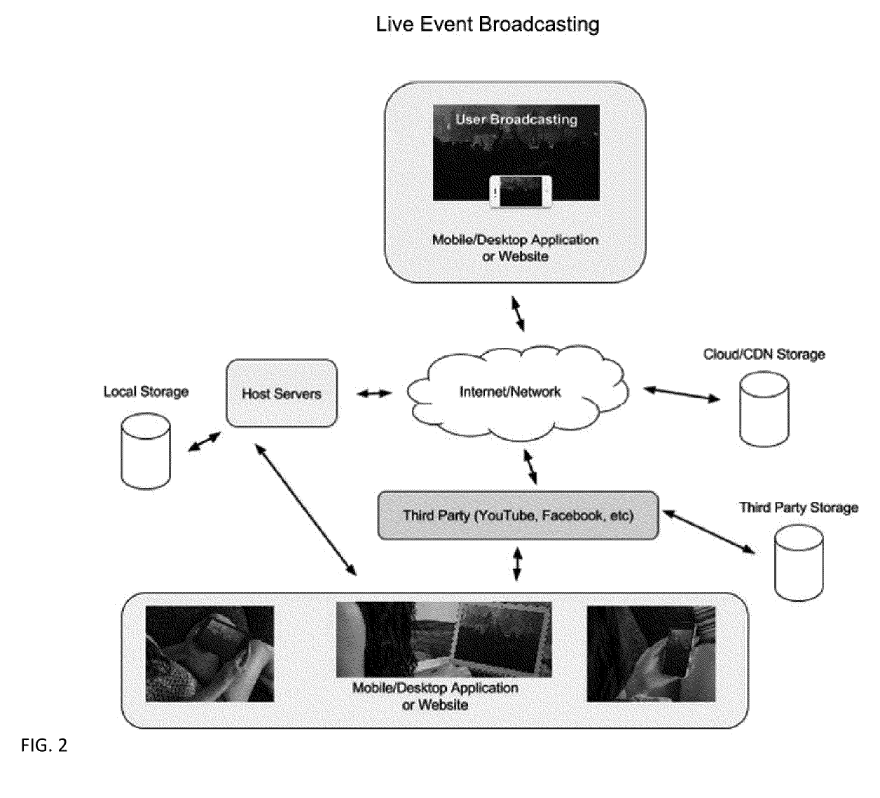

As shown in FIG. 2, the App provides artists with a platform to broadcast their live events, while simultaneously monitoring their social media and submitting posts on their favorite social networking websites. Each artist on the platform maintains a personal dedicated “Live Social” URL, such as www.tunego.com/artist-name/live. The Live Social page provides a platform to broadcast live events and communicate with their friends and social media followers in real time. The Live Social page allows artists to update their personal on the world's most popular social networking, either individually, or simultaneously all at once. The Live Social Feed displays the social posts from the world's most popular social networking websites in a single unified feed that displays the posts in reverse-chronological order. Artists will have the ability to filter the posts by social network, or display all posts in a single feed. Examples of supported social networking are Facebook, YouTube, Twitter, Google Plus, and Pinterest.

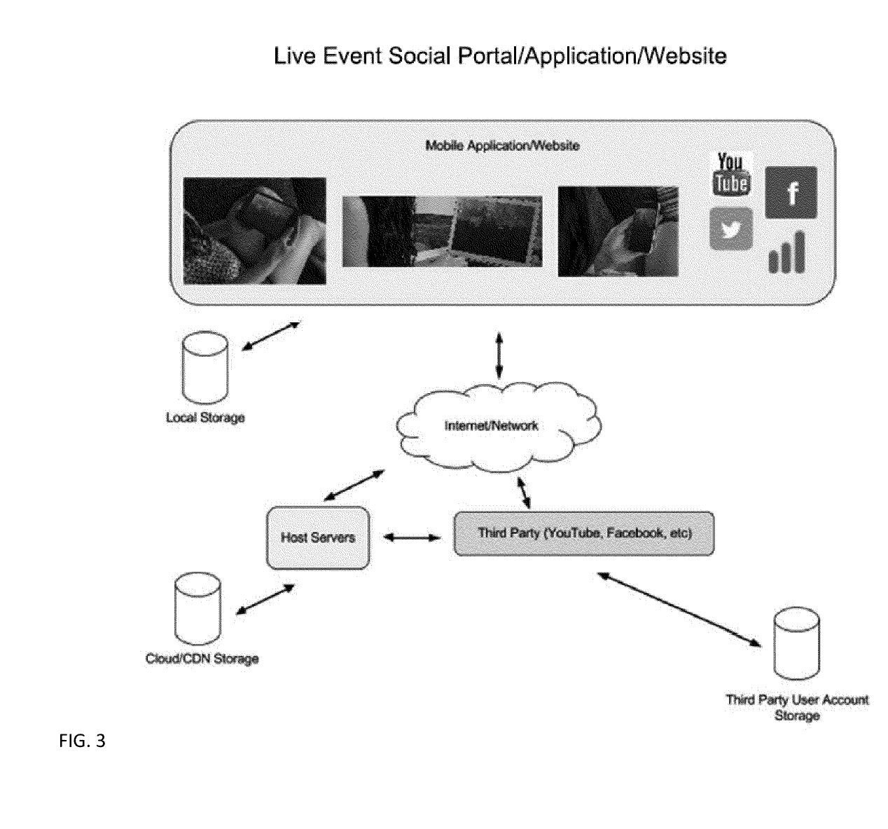

As shown, for example, in FIG. 3, the Live Social Page also serves as a stand-alone Facebook App that can be added to any user's Facebook Page. The Live Social Facebook App allows artists to add the Live Social Page to their personal Facebook Pages, allowing Facebook users to fully interact with all the features of the Live Social Page, within the Facebook environment. Artists can manage the Live Social Facebook App from their personal accounts, or from within Facebook.

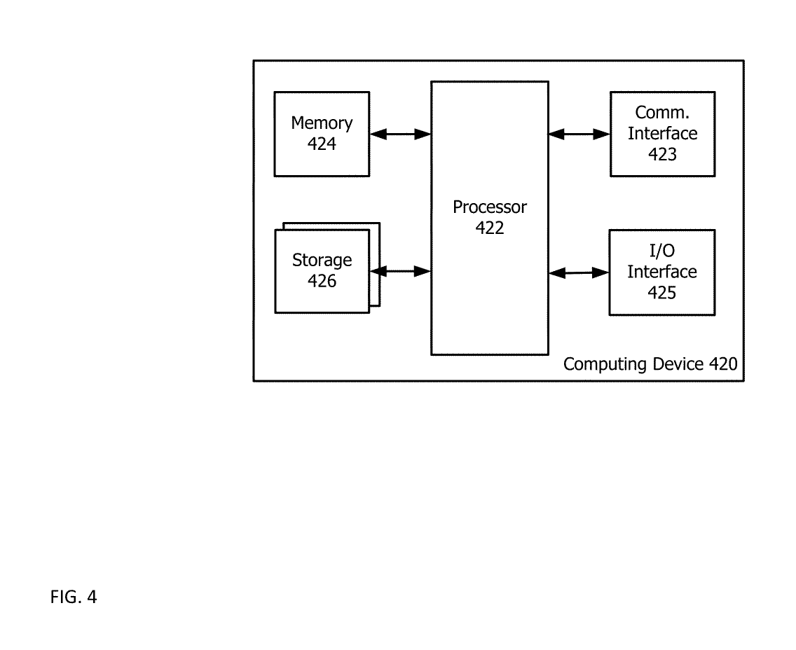

The computers described herein FIG. 4 is a depiction of a computing device 420. The computing device 420 includes a processor 422, communications interface 423, memory 424, and an input/output interface 425. Further, although these elements are shown independently of one another, each may, in some cases, be integrated into one another.

The computing device 420 is representative of the mobile devices and other computing devices discussed herein. For example, the computing device 420 may be or be a part of a mobile device or a server. The computing device 420 may include software and/or hardware for providing functionality and features described herein. The computing device 420 may therefore include one or more of: logic arrays, memories, analog circuits, digital circuits, software, firmware and processors. The hardware and firmware components of the computing device 420 may include various specialized units, circuits, software and interfaces for providing the functionality and features described herein.

The processor 422 may be or include one or more microprocessors, application specific integrated circuits (ASICs), or a system-on-a-chip (SOCs).

The communications interface 423 includes an interface for communicating with external devices. In the case of a computing device 420, the communications interface 423 may enable wireless communication with a mobile device. The communications interface 421 may be wired or wireless. The communications interface 421 may rely upon short to medium range wireless protocols like Bluetooth®, infrared, and/or 802.11x wireless.

The memory 424 may be or include RAM, ROM, DRAM, SRAM and MRAM, and may include firmware, such as static data or fixed instructions, boot code, system functions, configuration data, and other routines used during the operation of the computing device 420 and processor 422. The memory 424 also provides a storage area for data and instructions associated with applications and data handled by the processor 422.

The I/O interface 425 interfaces the processor 422 to components external to the computing device 420. In the case of servers and mobile devices, these may be keyboards, mice, and other peripherals.

The storage 426 provides non-volatile, bulk or long term storage of data or instructions in the computing device 420. The storage 426 may take the form of a disk, tape, NAND-based flash memory or other reasonably high capacity addressable or serial storage medium. Multiple storage devices may be provided or available to the computing device 420. Some of these storage devices may be external to the computing device 420, such as network storage, cloud-based storage, or storage on a related mobile device. This storage 426 may store some or all of the instructions for the computing device 420. The term “storage medium”, as used herein, specifically excludes transitory medium such as propagating waveforms and radio frequency signals.

How it Works:
1. The user downloads the mobile version of the App from the Google Android Play Store, or the Apple App Store. The user downloads the PC and Mac version of the App directly from a designated website.
2. The user installs the App on their device.
3. The user completes a registration process and supplies relevant personal information, such as name, email, mobile phone number, etc.
4. The user is required to “sync” their social accounts to the App, if the user wants to activate the live streaming and DVR features, as they are related to 3rd party websites such as YouTube, Facebook and Twitter.
   a. The user completes the Google Login, Facebook Login, and Twitter Login process, respectively, which allows access the user's personal websites accounts via the platform APIs.
   b. Users that do not sync their social accounts are still able to stream live video from the App, however the live streaming and DVR features will be limited.
5. Users will complete the registration process and will have an official account.
   a. Each user will maintain a personal web address of www.tunego.com/username.
   b. Each user will maintain a personal live video streaming web address of www.tunego.com/username/live
   c. Each user will be able to login to their personal account to edit/update their account information.
6. Once the account is created and the required live streaming software is installed on the user's device, the user will be able to instantly broadcast live video, or schedule live events at a future time and date.
   a. Instant Live Streaming:
      i. The user opens the App and initiates the live broadcast.
      ii. The live broadcast is transmitted from the user's device using the internet to proprietary servers, and/or 3rd party websites including YouTube, Facebook, and Twitter.
      iii. When broadcasting to YouTube, the App takes the following actions:
         1. App communicates with proprietary servers.
         2. An API call is generated to YouTube to initiate live event.
         3. Access information is received from YouTube to initiate the live broadcast.
         4. The live broadcast is initiated and the live event data (name of event, description, tags, user ID, etc.) is sent to YouTube and the live video is transmitted.
         5. Proprietary servers DVR live broadcasts locally and convert the files into “web-friendly” video formats for playback on multiple devices and bandwidth connections.
         6. YouTube sends the live video page URL to, e.g., www.youtube.com/user/live
         7. The YouTube video player is embedded containing the live transmission into the user's personal profile, e.g., www.tunego.com/username/live
         8. If the user synced their Facebook account, then an API call to Facebook will be initiated and the YouTube video player containing the live video will be automatically embedded to broadcast on the user's Facebook account.
         9. If the user synced their Twitter account, then an API call to Twitter will be initiated and the YouTube video player containing the live video will be automatically embedded to broadcast on the user's Twitter account.
         10. Upon the completion of the live broadcast, the recorded version of the live event will be automatically posted to the user's YouTube, Facebook and Twitter account, assuming these accounts are synced with the proprietary service.
         11. Upon the completion of the upload of the recorded video, YouTube APIs will supply the video URL for automatically embedding into the user's profile, under the archive video section residing at www.tunego.com/username/videos
      iv. If a user only broadcasts to the proprietary platform and not any 3rd party platforms, the following actions occur:
         1. The software installed on the device initiates a live event with the proprietary servers and initiates the live broadcast.
         2. The live broadcast is recorded and transcoded on cloud-based servers.
         3. The live broadcast is distributed over a cloud-based network for delivery to end users, utilizing web-based video delivery technology, i.e. Flash players, HTML5, HLS supported devices, etc.
         4. Upon the completion of the live event, the recorded video is automatically posted to the user's account at www.tunego.com/username/videos.

Sharing:
1. The user will have the ability to share live broadcasts on popular social sites, such as Facebook, Twitter, Pinterest, and others.
2. Live video broadcasts shared on Facebook will utilize the customized video player to embed the video directly into the user's Facebook Timeline and News Feed (Facebook account), i.e. live video playback is supported inside Facebook. The post on Facebook also contains the name of the live event, description, and a link back to the user's profile www.tunego.com/username/live.
3. Live video broadcasts shared on Twitter will utilize the customized video player to embed the video directly into the user's Twitter feed (Twitter account), i.e. live video playback inside Twitter is supported. The post on Facebook also contains the name of the live event, description, and a link back to the user's profile www.tunego.com/username/live.

Mobile Sharing:
1. The user will have the ability to share live broadcasts with their mobile contacts via SMS/MMS.
2. Users will be able to include custom messages when send live broadcast alerts via SMS/MMS.
3. SMS/MMS messages will contain a live video URL that will support playback on mobile devices, including Apple iOS, Google Android, Blackberry, and other mobile platforms.

How this Works:
1. The user will initiate a live broadcast and will have a “Share” icon located on the broadcasting software.
2. The user will click the Share icon and the user's native default messaging software will open with a pre populated message and link, for example: “I'm streaming live, check it out www.tunego.com/username/live.
3. When the recipient clicks on the shared link, they will be directed to the user's live streaming page that supports playback on mobile devices.

Live Event Scheduling:
1. The user has the ability to schedule future live events, by completing a form designating the following:
   a. Event name
   b. Event description
   c. Events meta tags
   d. Event start date and time.
2. The user has the ability to create future live events on both the proprietary service and YouTube, using the YouTube API to schedule the event on the user's personal YouTube account.
3. The user has the ability to share the future live event with their mobile contacts and social sites.

How this Works:
1. User initiates “Create New Event” function.
2. User designates if event is “Future Event”
3. User completes a form that collects information, such as event name, event description, meta tags, event start date and start time.
4. User completes setup of future live event.
5. User is presented with interface to share event details with mobile contacts and social websites.

Live Analytics and Social Data:
1. The App can collect and analyze live broadcast user data generated from proprietary web properties and from 3rd party websites and applications such as YouTube, Facebook and Twitter.
2. The APIs of 3rd party platforms may be utilized to collect live event data, such as total number of viewers, concurrent viewers, average viewing time of live event, etc.
3. The APIs of 3rd party platforms may be utilized to collect social data, such as impressions, interactions, shares, Facebook Likes, Twitter Tweets, etc.

How this Works:
1. User initiate live broadcasts using the platform.
2. The software tracks all user activity generated on proprietary web properties and mobile apps.
3. When the user initiates a live broadcast from TuneGO to YouTube, TuneGO collects data from the YouTube Analytics API, such as total viewers, concurrent viewers, average viewing length, etc.
4. When the live broadcast is shared on a user's social sites, such as Facebook, Twitter, Pinterest, Google Plus, and others, data may be collected from the respective APIs of the social sites, such as impressions, interactions, shares, Likes, Tweets, Pins, etc.
5. Users will have secure access to live analytics and social data from their personal profiles.

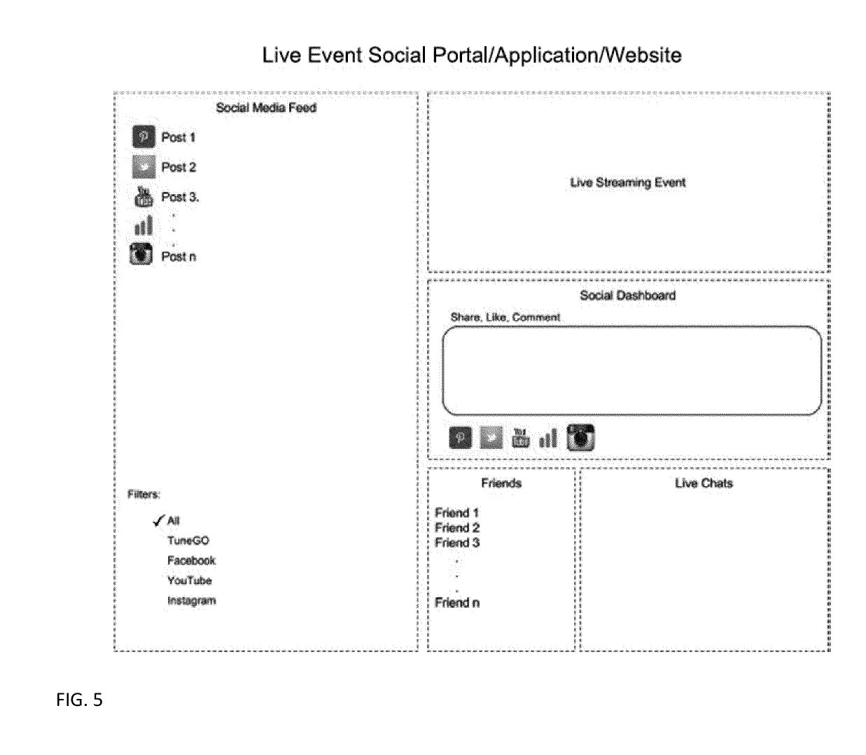

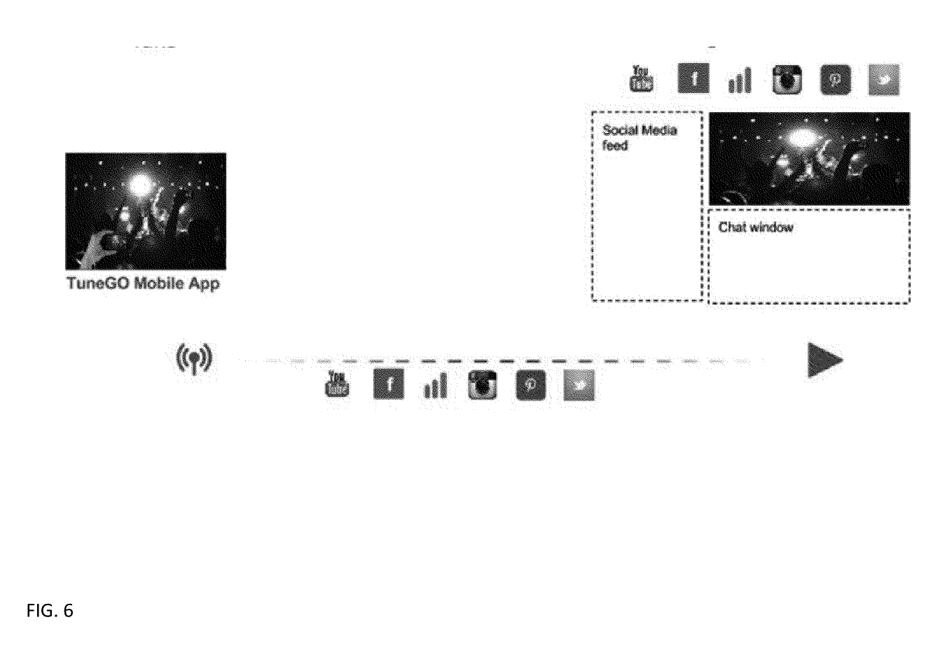

Real Time Social Monitoring and Display:
1. The Live Streaming profile page www.tunego.com/username/live (e.g. FIGS. 5 and 6) is a web-based page that displays the user's live broadcast, coupled with real time social media posts, comments, and other forms of interactions from popular social sites, such as Facebook, Twitter, Pinterest, Google Plus, etc.

How this Works:
1. The user will initiate a live broadcast that is received by the video player on the user's live streaming profile page, for example: www.tunego.com/username/live
2. The APIs of the popular social sites will be used to collect the activity generated by each social website, as related to the user and the live broadcast.
3. The user's Live page will display the aggregate activities collected from each social site in reverse-chronological order (newest activity displayed first).
4. Users and viewers will have the ability to click on any social activity and link to the original activity located on the 3rd party social site of origin.
5. Users and viewers will have the ability to view activities from all of the aggregate social sites in real time. As the data is collected from the social APIs, the activities are displayed on the user's live social feed. The front end will utilize a technology such as Ajax to automatically push new updates to the user's activity feed, without the requirement of refreshing a browser or app.

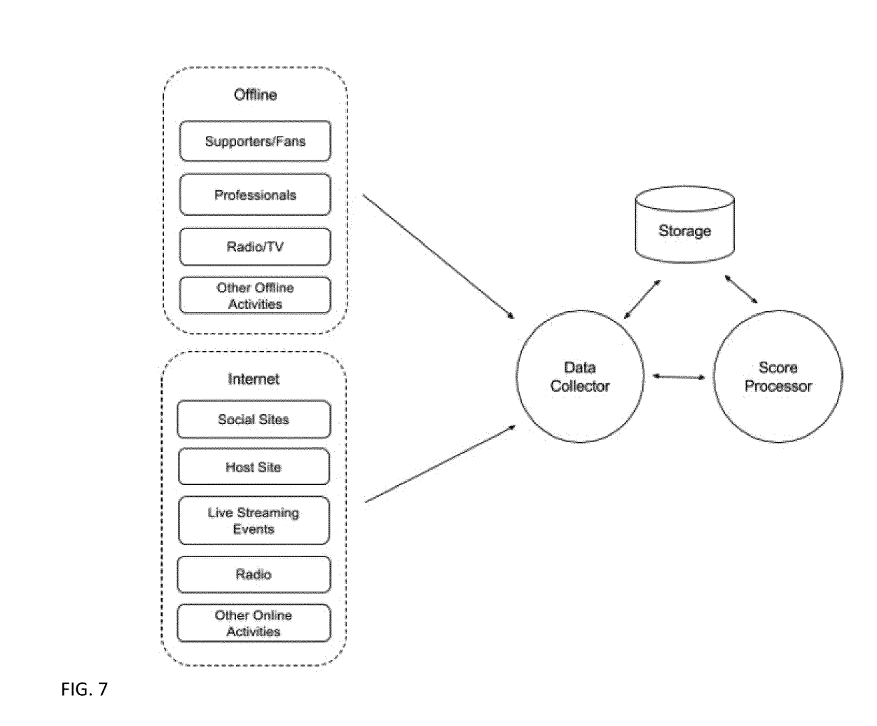

Our artist scoring system, shown in FIG. 7, combines social data, fan analytics, review data, feedback from industry professionals and fans, and other data to generate a score that is used in identifying, ranking and qualifying artists. Similar to a credit or scholastic assessment test score the score provides a metric to measure and rank artists against other artists across various categories. There are two types of scores: a “Lifetime Score” which is a cumulative score that rises over time as the artist continues to amass points and a “Trending Score” that is a time sensitive score that will fluctuate up and down based on various time sensitive criteria and algorithms.

These scores provide A&R and other music professional's data to assist them in the process of identifying and discovering artists of interest. The artists' scores may also be used in many ways to enhance a music consumer's experience and assist in filtering and categorizing content.

The score will be used as the foundation for an artist and fan competitive reward system to incentivize, motivate and reward both artists and fans to perform actions to advance an artist's score. Music fans will compete against other fans to earn points and rewards by performing various actions to earn points and boost an artist's score.

Independent artists and musicians may set up their artist profile that includes their picture, music, bio and other information. Included on their profile is a score that is calculated from various data sources and assigned to the artist. Artists may be incentivized to increase their score to qualify for various opportunities/rewards. As the artist increases their score their ranking will improve providing the artist greater prominence and visibility to a community of music fans (consumers), professionals and partners.

Data Sources and Activities

The score will be calculated and maintained based on activity and data from various sources. The following is a list of some of the different types of data that will be collected and analyzed to produce a score for each artist.

Website/Mobile App
Artist Profile and Media Activity
   Number of song and video plays
   Number of comments, profile views/visitors
   Number of likes, shares, votes, followers
Artist Live Events Activities
   Number of views/viewers
   Number of comments
   Number of likes, shares, votes
Artist Activities
   Number of invites, shares
   Number of comments
Fan Activities that contribute to the Artists score
   Sharing artist assets such as profile, song, video, live event, etc. . . .
   Liking, following, voting, recommending artists assets
   Commenting and reviewing artist assets

Activity on Third Party Sites/Apps
Artist Media Activity
   Number of songs and video plays on third party sites and apps such as youtube, facebook, twitter, etc.
   Number of likes on third party sites and apps.
Artist Profile Activity
   Number of comments, profile views/visitors
   Number of likes, shares, votes, followers

Offline Data Sources
Feedback and reviews from music professionals
Feedback and reviews from other music professionals
Feedback and reviews from fans
Feedback and reviews from other fans
Data from syndicated radio and tv station
Career achievement data such as awards won, award nominations, live performance statistics, record sales, etc.

How Data is Collected and Calculated

Data may be collected from both proprietary and third party websites and apps.

Artist activities and interactions on the proprietary website and app may be monitored, recorded and stored in a database. Periodically or in real-time, data may be retrieved from third party sites and apps that related to the artist such as Facebook followers, YouTube video plays, etc. In some cases to retrieve data from the third parties the artist will be required to “sync” their account and connect it with their user account from the third parties such as YouTube or Facebook for access to their third party account data. The data may be processed using various algorithms to determine an artist's score.

Types of Scores

There will be at least two types of scores for an artist—a “Lifetime Score” and a “Trending Score”. The “Lifetime Score” is a cumulative score that is started from the time the artist registers with the service and over time continues to amass as long as the artist is a member on the service. The “Trending Score” is a time sensitive score that will fluctuate up and down based on various time sensitive criteria and algorithms.

How Will the Score be Used

The score will be used throughout the proprietary website and app to highlight and rank the artists. The score will be used to generate weekly charts and other lists showing which artists are trending or popular. Another use of the score is to determine which artists are eligible for various opportunities or rewards. For example an artist with a minimum score of 10,000 will qualify for an opportunity to be selected as the featured artist of the week. The score will also be used as input into the process of determining “featured” artist selections. A&R and other professionals will use the score to assist them in their process of filtering, searching and identifying talented artists of interest.

Artist and Fan Competitive Reward System

The score provides a metric to motivate artists to compete and earn opportunities to help them advance their careers. Music fans will also be motivated to compete and earn rewards while assisting artists in advancing their artist scores. As music fans support artists in raising their score the fan they will be recognized by the artists as the artist will have visibility into who are their most active supporters and contributors to their success. Artists can then acknowledge, interact and reward their fans with things like tickets, backstage passes, t-shirts, etc. . . . to incent their loyal supporters.

The artist and fan competitive reward and scoring system provides a platform to create a gaming environment for fans to compete with others or against themselves. In the gaming environment artist will be assigned a dollar (market) value based on their score and other factors. The artist's market value will fluctuate based on the artist's score, demand and other indicators of popularity or success. Similar to investing in stocks or real estate fans will be able to grow the dollar value of their portfolio of artists. Fans compete against other fans/players by virtually signing artists, developing emerging talent, selling contracts, managing artists, building a record label and other actions that are performed both “virtually” and “actually”. Fans can perform both “virtual” and “actual (real)” actions. Virtual actions would include signing an artist to a contract, selling an artist's contract and other virtual gaming actions. Actual actions would include sharing an artist's song or posting it on social media to earn the fan gaming points and increase the virtual market value of an artist. These “real world” actions will generate gaming score points/value but will also have real life implications to an artist by increasing their artist score and giving the artist “real” world exposure.

Fans/music consumers will also be able to amass gaming points through a multi-level scoring algorithm similar to the compensation system used by multi-level marketing companies. Not only will music fans earn points for sharing an artist and their media with their friends but they will also be reward points for the activities that occur “downline” as they are performed by their referrals and the referrals of the referrals and so on.

Description of Processes

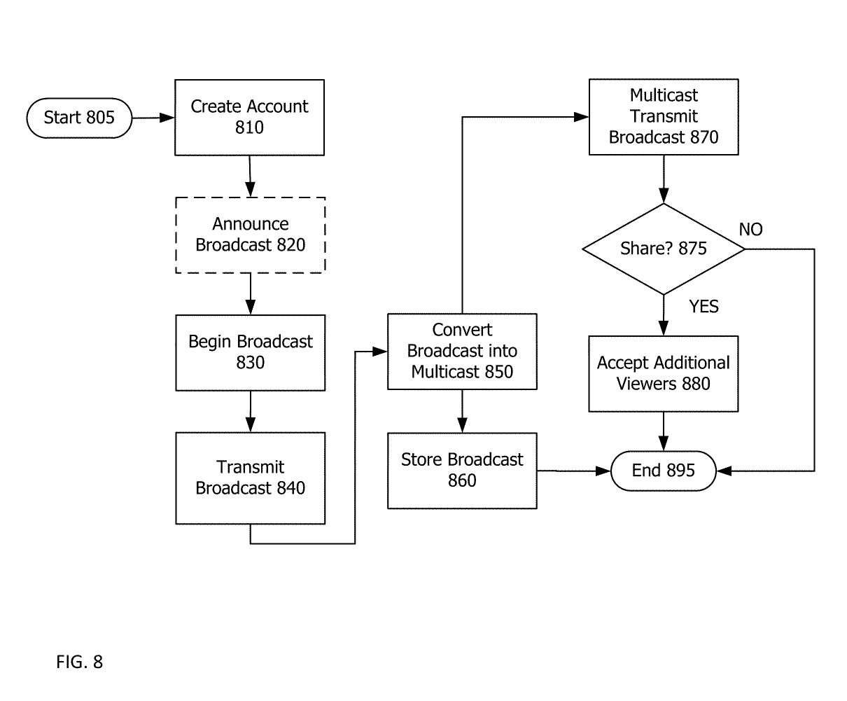

FIG. 8 is a flowchart of the process of live event broadcasting. The process begins at start 805 and ends at end 895, but may be cyclical in nature. First, a user (or a broadcaster) may make an account at 810 as discussed above. Next, the broadcast may be scheduled and pre-announced at 820. This announcement may take place weeks or months in advance or may only occur as or at the same time that a broadcast is happening. Similarly, if a social network contact of a user begins watching a particular broadcast, an announcement may be made at that time. This step is shown in dashed lines because it is optional.

Next, the broadcast of the live event is begun at 830. Next, the broadcast is transmitted, for example, to a server for re-transmission to multiple users. As discussed above, this transmission at 840 may involve the capture of an event as a video stream and the transmission of the video stream to a server.

Next, the captured video stream is converted into a multicast video stream at 850. This may be performed, for example, by a remote server. Substantially simultaneously, the video stream may be stored for later use at 860. For example, the stored broadcast may be uploaded to one or more video serving sites, like YouTube, for transmission upon request at a later date. This may be under the control of the artist or recorder of the live event.

Next, the multicast video stream is broadcast at 870. This may be, for example, by UDP transmission of data packets that may be received by a device listening for the multicast video stream. In this way, the bandwidth usage returning to the server is minimized.

The recipient of the broadcast at 870 may elect to share the video at 875, as discussed above by SMS/MMS, chat, social network, email, websites or other systems. If a user chooses not to do so, the process ends at 895. If the user chooses to do so, then the server may accept additional viewers at 880 and add them to the multicast video stream transmission. The process then ends at 895.

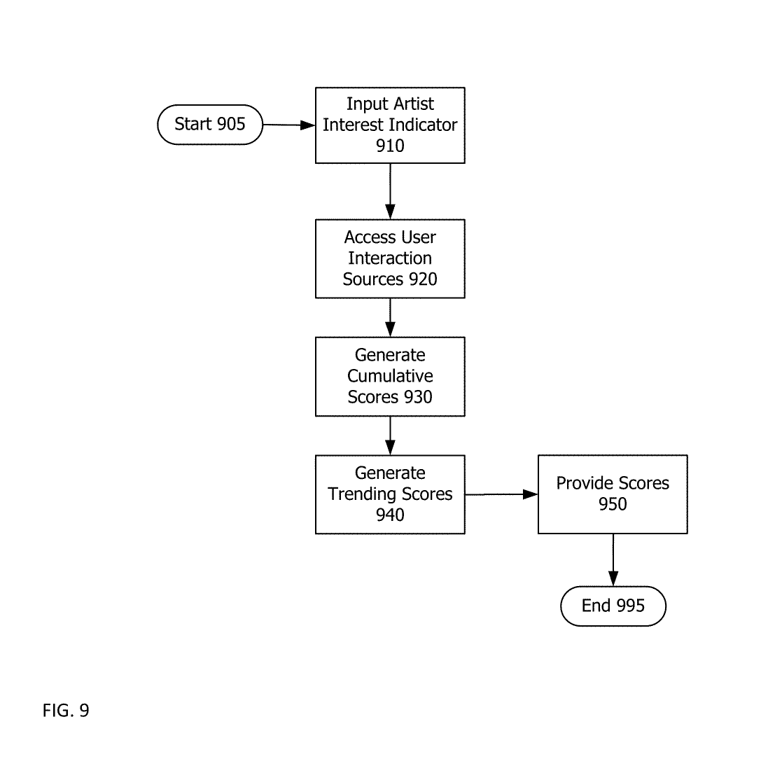

FIG. 9 is a flowchart of artist scoring. The flow chart has both a start 905 and an end 995, but the process is cyclical in nature.

First, after the start 905, an artist input indicator is input by a user at 910. This may be, as discussed above, a “like” on Facebook®, a “view” of a video, such as a video stored as discussed above with respect to FIG. 8, a mention or a “tag” on a social network like Twitter®, Facebook®, or the like. In either case, the artist input indicator is created by one or more users at 910. This may be an ongoing process.

Next, the server accesses user interaction sources 920 to search for new artist interest indicators at 920. This may be an updated “views” listing or “likes” listing from a video serving site or from a social network indicating that additional artist interest indicators have been processed. These may be accessed in order to create a new set of scores for an artist.

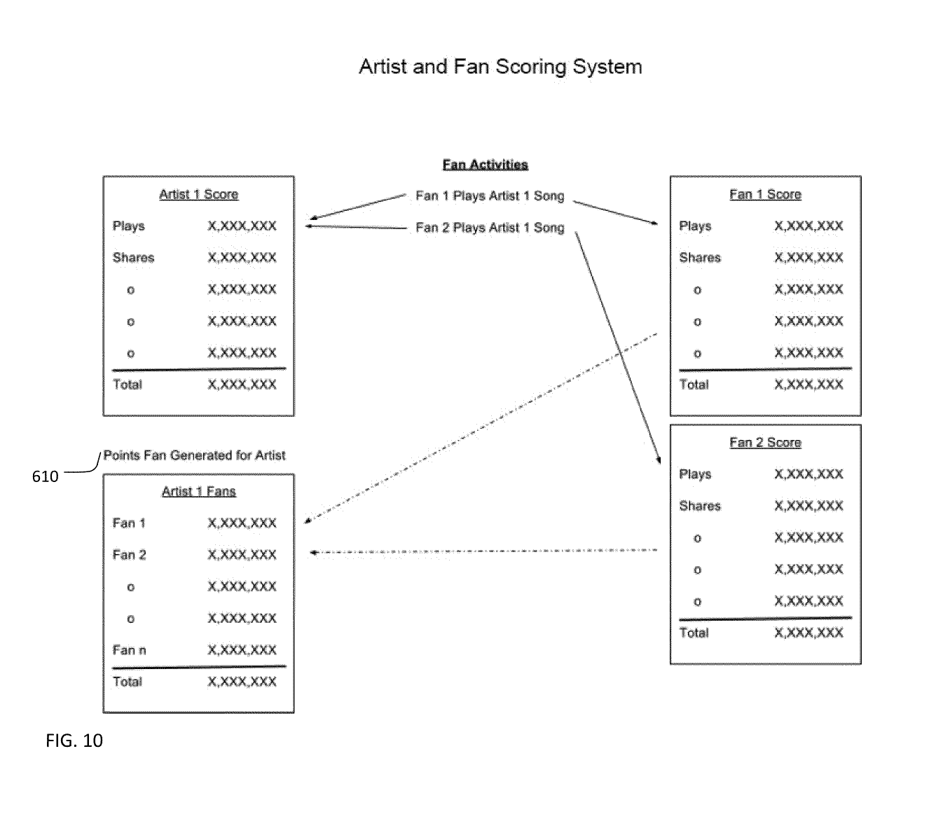

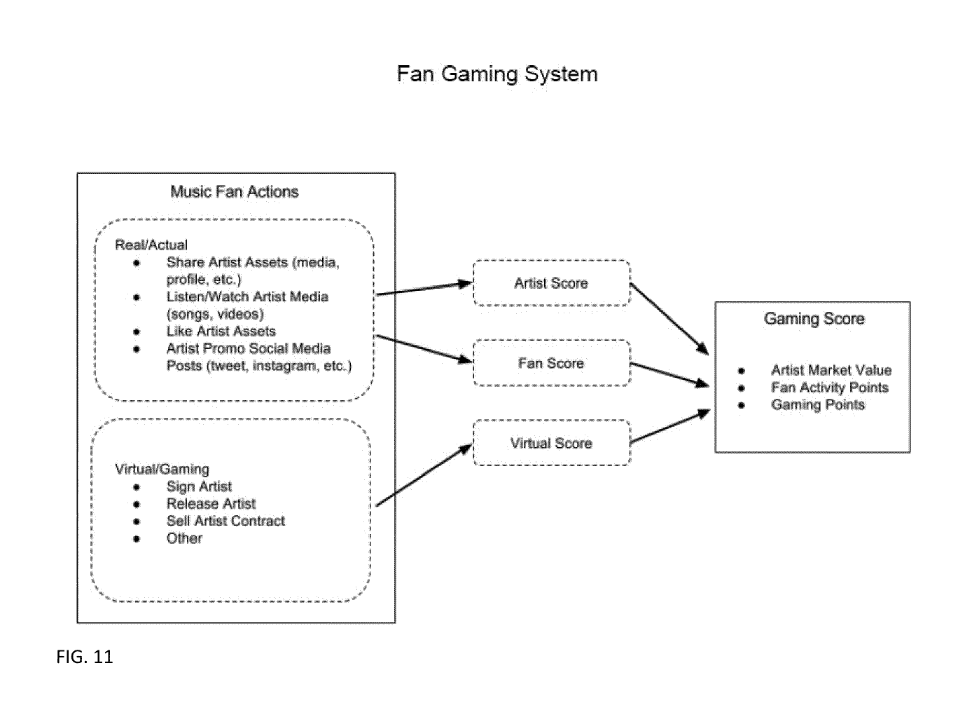

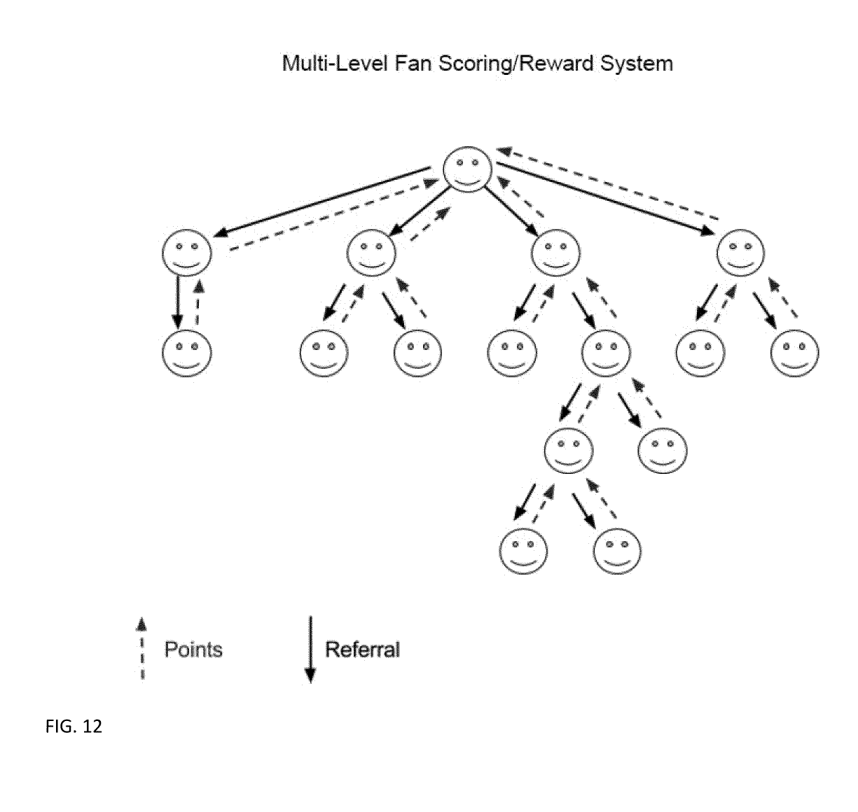

Next, the cumulative scores may be generated at 930 by simply adding additional users, likes, views and similar artist interest indicators to the cumulative score. An example of this is shown in FIG. 10 which FIG. 10 shows an example of artist scoring based upon fan activities. FIG. 11 shows an example of the types of fan activities and their results on artist scoring. FIG. 12 shows an example of multi-level fan scoring reward system whereby referral of an artist to another user results in points being allocated to the referring user and, recursively, to still further referring users and, eventually, the artist themselves.

Similarly, the trending scores may be generated at 940 by determining the number of artist interest indicators within a pre-determined time period or comparatively with other artists (or artists of the same type or genre, e.g., country artists, rap artists, comedians, etc.).

Finally, the scores may be provided at 950 to one or more of fans, the public, the artists themselves, professional artist selectors (like A&R at record companies), and advertisers. The scores may be useful in identifying relevant artists for each of their needs.

### CLOSING COMMENTS

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A server for live stream broadcasting of video comprising:
a network interface for receiving the video stream of a live event substantially simultaneously with the recording of the video stream to a server; and
a processor for converting the video stream into a plurality of multicast video streams, each suitable for viewing by one of a plurality of computing devices;
the network interface for simultaneously retransmitting the plurality of multicast video streams to the plurality of computing devices, and transmitting an announcement that the multicast video streams are available for viewing to a plurality of mobile devices.

2. The server of claim 1 wherein the server further comprises:
data storage for storing the video stream on the server;
the processor is further for converting the video stream into at least one format suitable for later viewing by a computing device and making the stored video available for viewing after the live event has completed.

3. The server of claim 1 wherein the announcement is transmitted via one of short message service, multimedia message, a social network, and another video transmission.

4. The server of claim 1 wherein the announcement is transmitted more than an hour before the live event begins.

5. The server of claim 1 wherein the announcement is transmitted upon initiation of transmission of the multicast video streams.

6. A method for live stream broadcasting of video comprising:
receiving the video stream of a live event substantially simultaneously with the recording of the video stream to a server;
and converting the video stream into a plurality of multicast video streams, each suitable for viewing by one of a plurality of computing devices;
simultaneously retransmitting the plurality of multicast video streams to the plurality of computing devices;
transmitting an announcement that the multicast video streams are available for viewing to a plurality of mobile devices.

7. The method of claim 1 further comprising:
storing the video stream on the server;
converting the video stream into at least one format suitable for later viewing by a computing device;
making the stored video available for viewing after the live event has completed.

8. The method of claim 6 wherein the announcement is transmitted via one of short message service, multimedia message, a social network, and another video transmission.

9. The method of claim 6 wherein the announcement is transmitted more than an hour before the live event begins.

10. The method of claim 6 wherein the announcement is transmitted upon initiation of transmission of the multicast video streams.

11. Apparatus comprising a storage medium storing a program having instructions which when executed by a processor will cause the processor to live stream broadcast video, the instructions of the program for:
receiving the video stream of a live event substantially simultaneously with the recording of the video stream to a server;
converting the video stream into a plurality of multicast video streams, each suitable for viewing by one of a plurality of computing devices;
simultaneously retransmitting the plurality of multicast video streams to the plurality of computing devices;
transmitting an announcement that the multicast video streams are available for viewing to a plurality of mobile devices.

12. The apparatus of claim 11 wherein the instructions of the program are further for:
storing the video stream on the server;
converting the video stream into at least one format suitable for later viewing by a computing device;
making the stored video available for viewing after the live event has completed.

13. The apparatus of claim 11 wherein the announcement is transmitted via one of short message service, multimedia message, a social network, and another video transmission.

14. The apparatus of claim 11 wherein the announcement is transmitted more than an hour before the live event begins.

15. The apparatus of claim 11 wherein the announcement is transmitted upon initiation of transmission of the multicast video streams.

16. The apparatus of claim 11 further comprising:
a processor
a memory
wherein the processor and the memory comprise circuits and software for performing the instructions on the storage medium.
